(19) United States
(12) Patent Application Publication
(10) Pub. No.: US 2013/0036666 A1
(43) Pub. Date: Feb. 14, 2013

(54) Bio-degradable Fertilizer Pad

(71) Applicant: Gary N. Estepp, Albuquerque, NM (US)

(72) Inventor: Gary N. Estepp, Albuquerque, NM (US)

(21) Appl. No.: 13/493,141

(22) Filed: Jun. 11, 2012

Related U.S. Application Data
(60) Provisional application No. 61/574,797, filed on Aug. 10, 2011.

(51) Int. Cl. A01G 29/00

(52) U.S. Cl. 47/48.5

(57) ABSTRACT

Convenience in American lives promotes business. Gardening often requires weeding, fertilizing and watering on a regular basis. The frequency of these tasks is weather and climate dependant. The dryer climates of the Southwest require daily watering of gardens. Dry fertilizers are washed away with excessive watering. A single product that minimizes weeding, eliminates fertilizing, eliminates the need to apply mulch and reduces watering, while providing a biodegradable product has been invented.

### CROSS-REFERENCE TO RELATED APPLICATIONS

This application claims the benefit of priority filing of U.S. Provisional Application Ser. No. 61/574,797, entitled “Bio-degradable fertilizer-pad.” Filed Aug. 10, 2011, the entire disclosure of which is hereby incorporated by reference.

The object of this invention is Biodegradable Fertilizer-Pad. This pad is a consumable which will last only one growing season. This fertilizer-pad is made of short fiber recycled paper in a corrugated cardboard profile forming up to a 1 inch thick ring pad. The short fibers were chosen to offer a weak physical structure which slowly degrades in the presence of water. After four months exposure to regular watering and the environment, the fertilizer-pad will simply fall apart and become mulch in the garden. The pad can be configured in two interlocking halves or a ring with a narrow slot or be a single split ring. The vertical structure allows water to fill the exposed tubular structures which slowly drain to water the plant. Several tubes are loaded with slow dissolving fertilizer and some possibly with weed/insect killer. Two or more sizes may be available for different plants but in most cases a simple 3/4 inch thick, 12 inch OD with a 2 inch ID hole will suffice for gardening needs or as small as a 1/4 thick, 3 to 4 inch diameter with a 1 inch hole for small plants. Different configurations will be made for different applications.

### REFERENCE PATENTS

4,474,595 Lawhon Jr.; William T.; “Fertilizer product . . . .”, Oct. 2, 1984

5,127,933 Hallett, Arne L.; “Complete fertilizer and ”, Jul. 7, 1992

4,965,960 Moore; James E.; “Method and devices ”, Oct. 30, 1990

4,947,580 Moore; James E.; “Manual devices and ”, Aug. 14, 1990

4,719,719 Stevens; Alec M., “Applicator disks”, Jan. 19, 1988

2006027170-A1 Smith; Gerald M., “Hair Felt”, Sep. 21, 2006

20060117653-A1 Werth; Fred, “Seed Mat”, Jan. 8, 2006

### BACKGROUND OF THE INVENTION

1. Field of the Invention (Technical Field)

The invention relates to fertilizing, mulch application, weed blocking and water retention of house or garden plants by a bio-degradable material pad.

2. Background Art

House and garden plants require regular watering and fertilizing. The amount required is dependant on soil condition, weather and climatic conditions of the area. Mulch may be required in certain soil/climate conditions to enhance moisture retention. Garden plants also require regular weeding to maintain the optimal health of the plants.

Many fertilizers are available in liquid, granular and stick form. Liquid and granular fertilizers must be reapplied regularly to have the optimal benefit. The stick or spike fertilizers are typically applied once a growing season. Some potting soils are available with slow dissolving fertilizer that last up to three months.

Insects also invade gardens destroying healthy plants. Pesticides are applied to prevent and eliminate these garden pests.

From the foregoing background, the present invention was developed.

### SUMMARY OF THE INVENTION

The invention relates to a single pad which is bio-degradable. More specifically, provides a convenient means to supply fertilizer, retain moisture and block weed growth and may also prevent insect damage. Various embodiments of the invention preferably would include plant related formula fertilizers, weed blockers and pesticides, including thickness, diametric and material changes related to plant size, container size or tree size.

An object of the invention is to provide a low cost, single season bio-degradable pad which can be turned into the soil at the end of the growing season.

An advantage of the invention is that it offers a convenient means to fertilize continuously through the growing season.

Another advantage of the invention is that it may contain plant species specific fertilizers.

Available for tomatoes, vegetables, flowers, roses, ornamental plants and trees, fruit trees or citrus trees.

Another advantage of the invention is that it retains moisture in dry climates.

Another advantage of the invention is that it prevents weed growth around the base of the plant.

Another advantage of the invention is that it may contain weed killer to prevent weed growth near the plant.

An advantage of the invention is that it may contain insecticides for garden or specific insects.

An advantage of the invention is that it may be available for potted plants, different size garden plants, bushes and trees.

An advantage of the invention is that it may be manufactured from recycled fiber.

Another advantage of the invention is that it may be manufactured from plant fiber or seaweed.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

FIG. 1 is a Top view of one preferred embodiment of the present invention, showing a Fertilizer-Pad with a slot.

FIG. 1 A-A is a Cut-Away Side View of the embodiment shown in FIG. 1.

FIG. 1b is a detail of the tubular structure of the preferred embodiment shown in FIG. 1.

FIG. 1c is a detail of the concentrically rolled fiber board of the preferred embodiment shown in FIG. 1.

FIG. 1d is a detail of one possible slot design of the preferred embodiment shown in FIG. 1.

FIG. 1e is a detail of one possible placement of slow dissolve fertilizer of the preferred embodiment shown in FIG. 1.

FIG. 2 is a Top view of one preferred embodiment of the present invention, showing a Fertilizer-Pad with a split ring.

FIG. 2 A-A is a Cut-Away Side View of the embodiment shown in FIG. 2.

FIG. 2a shows a detail of one possible split design of the embodiment shown in FIG. 2.

FIG. 2b shows a detail of one possible interlocking design of the embodiment shown in FIG. 2.

FIG. 3 shows one possible design of the preferred embodiment of the present invention showing a Fertilizer-Pad for seed starting.

FIG. 4 shows a Top and side view of one possible design of the embodiment of the present invention showing a Fertilizer-Pad made of pressed fiber with a slot.

This fiber may be wood, plant, recycled paper, corn husk, nut shell, sea weed and many other fibrous material as long as it is quickly bio-degradable. The fertilizer may be absorbed or encapsulated by the fiber during fabrication as to allow the fertilizer to be released as the fiber structure beaks down when exposed to water and weather. If sea weed is used, no added fertilizer may be needed.

### BRIEF DESCRIPTION OF THE PREFERRED EMBODIMENTS

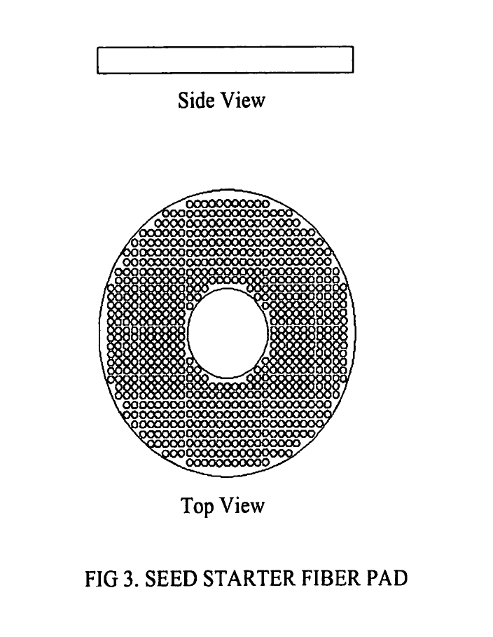

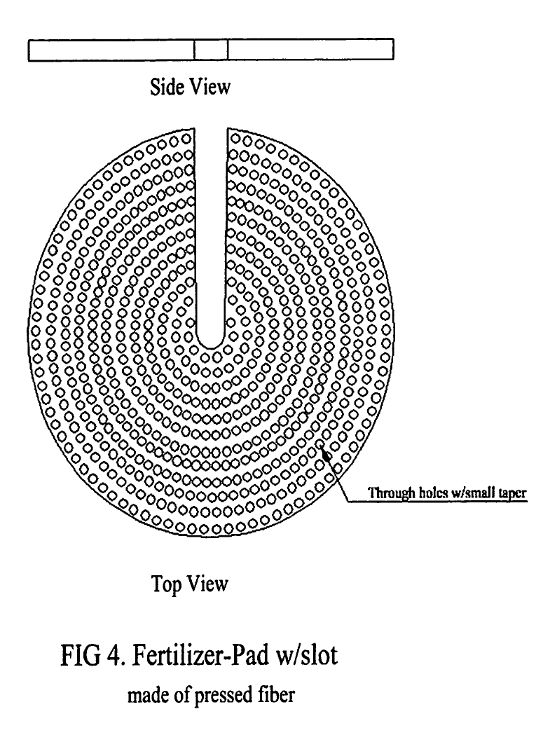

Broadly described the present invention is a plant pad which delivers a season long supply of fertilizer while retaining moisture and blocking weed growth around plant. Referencing FIGS. 3 & 4, the preferably formed of recycled cardboard fiber where the preformed fiber solution is saturated with fertilizer, both fully dissolved and partially dissolved. Recycled fiber is preferred because of the inherent weakness of short fibers over longer virgin fiber content. Then molded and/or pressed into the desired form, with or without a slot and dried. Through normal degradation due to weather/watering, the fiber degrades and fertilizer is released over the growing season. This fiber degradation appears to significantly breakdown over a four month period of normal plant watering and nearly complete breakdown within six months. The remaining fiber may be turned into the soil as a light-mulch.

Alternately a plant pad formed of seaweed, where the amount of additional fertilizer may be minimized. Again molded or pressed into a shape to provide a mulch-like plant pad which delivers the nutrients required for a healthy plant.

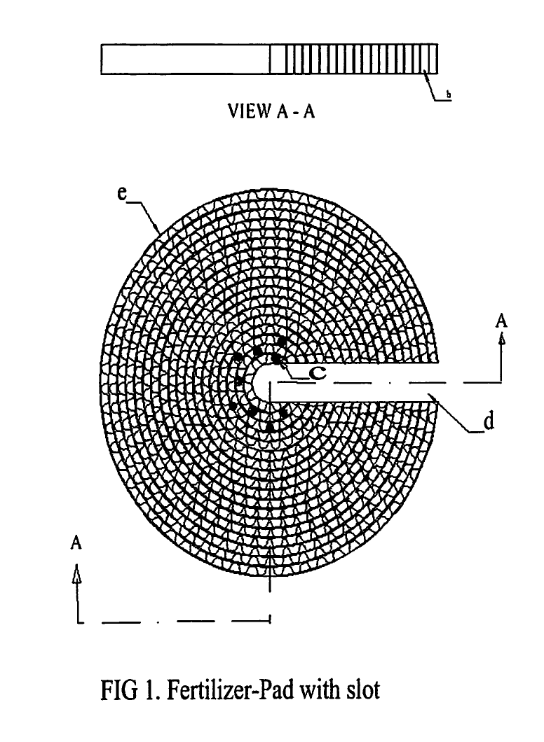

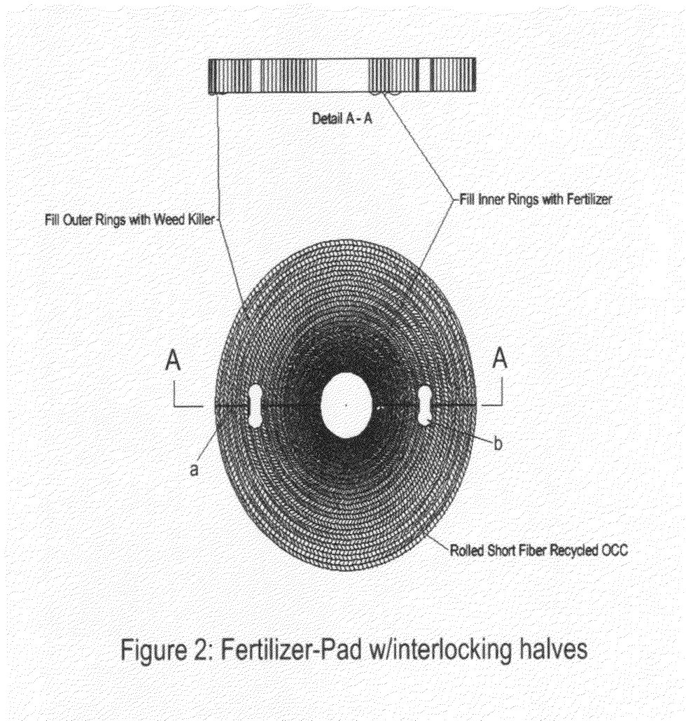

Referencing FIGS. 1 & 2, alternately may be formed by rolling cardboard to form the cylindrical form. Loading some holes with fertilizer, some with slow dissolve fertilizer and some with optional weed blockers and/or insecticide to accomplish the same action as described above. Cutting a slot to allow use with started plants and no slot for seed starters may be desirable. Alternately, may be cut in half with an interlocking feature for ease of placing around a larger plant or tree.

1. A Bio-degradable medium which retains water.

1a. Referring to claim 1, a Bio-degradable medium which blocks weed growth.

1b. Referring to claim 1, a Bio-degradable medium which contains fertilizer.

1c. Referring to claim 1, a Bio-degradable medium which contains insecticide.

1d. Referring to claim 1, a Bio-degradable medium which contains weed killer.

1e. Referring to claim 1, a Bio-degradable medium which aids in plant growth.

1f. Referring to claim 1, a Bio-degradable medium which releases fertilizer as the fibers breakdown.

2. A Bio-degradable plant pad made of fiber material, such as paper or cardboard.

2a. Referring to claim 2, a Bio-degradable plant pad made of fiber material, such as plant fiber.

2b. Referring to claim 2, a Bio-degradable plant pad made of other material, such as nut shell.

2c. Referring to claim 2, a Bio-degradable plant pad made of plant material, such as husks.

2d. Referring to claim 2, a Bio-degradable plant pad made of sea weed.

2e. Referring to claim 2, a Bio-degradable plant pad used as a nursery starter pad which aids the development of plants.

2f. Referring to claim 2, a Bio-degradable plant pad used as a decorative plant pad.

2g. Referring to claim 2, a Bio-degradable plant pad used as a decorative tree pad.
